(19) United States
(12) Patent Application Publication
(10) Pub. No.: US 2006/0136951 A1
(43) Pub. Date: Jun. 22, 2006

(54) Optical head capable of recording and reproducing information on any one of a plurality of kinds of optical information recording medium and optical information recording and reproducing apparatus using the same

(76) Inventors: Takeshi Nakao, Sagamihara (JP); Nobuhiro Konuma, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/282,709

(22) Filed: Nov. 21, 2005

(30) Foreign Application Priority Data
Nov. 22, 2004 (JP) 2004-337462

(51) Int. Cl. G11B 7/08; G11B 7/085

(52) U.S. Cl. 720/659

(57) ABSTRACT

An optical disc apparatus compatible with both BD and HD-DVD specifications and also compatible with DVD and CD. An optical head has a first light source for emitting light having a first wavelength, a second light source for emitting light having a second wavelength, a third light source for emitting light having a third wavelength, a first objective lens for irradiating light emitted from the first or second light source to an optical disc, and a second objective lens for irradiating light emitted from the first or third light source to an optical disc. A light source and objective lens to be used are changed in accordance with BD, HD-DVD, DVD and CD.

### INCORPORATION BY REFERENCE

The present application claims priority from Japanese application JP2004-337462 filed on Nov. 22, 2004, the content of which is hereby incorporated by reference into this application.

### BACKGROUND OF THE INVENTION

The present invention relates to technologies of recording or reproducing information in or from an optical information recording medium such as an optical disc, and more particularly to an optical head compatible with a plurality of optical discs having different thicknesses of a substrate or a recording film protective layer (hereinafter these are collectively called an optical transmission layer) and to an optical information recording and reproducing apparatus.

An optical disc apparatus is an optical information recording and reproducing apparatus characterized in non-contact, large capacity, high speed access, low cost and the like. By positively incorporating these characteristics, the optical disc apparatus is used as a recording and reproducing apparatus for digital audio signals or an external storage apparatus of a computer. As the application field is broadened, the performance of the optical disc apparatus is becoming high so that it is essential to improve various performances of an optical head.

In order to improve a record density of an optical disc apparatus, it is effective to shorten a light source wavelength and increase a numerical aperture. The following two specifications have been proposed as the specifications of a high density optical disc using blue-violet laser having a wavelength of about 400 nm.

(1) Blu-ray (BD) Disc specifications using a high NA objective lens having a numerical aperture (NA) of 0.85 and an optical disc having a recording film protective layer thickness of 0.1 mm.

(2) HD-DVD specifications using an objective lens having a numerical aperture (NA) of 0.65 and an optical disc having a substrate thickness of 0.6 mm.

An optical disc apparatus compatible with three kinds of optical discs BD/DVD/CD is commercially available as an AV recorder, which apparatus adopts the BD specifications described in (1) and has an optical head capable of recording and reproducing DVD/CD in addition to an optical head for recording and reproducing BD.

If optical discs of the BD and HD-DVD specifications are widely used in the future, high demands are expected for optical disc apparatus compatible with both the BD and HD-DVD specifications and with both the DVD and CD media.

The apparatus of this type is desired to mount an optical head compatible with recording and reproducing all kinds of optical discs by using one objective lens. However, at the present time an objective lens realizing this operation is not practically realized. From this reason, an optical information recording and reproducing apparatus has been proposed which has a function compatible with a plurality kind of optical discs by providing a plurality of objective lenses corresponding to each optical disc or plural optical discs.

For example, the following technologies (a), (b) and (c) are now presented.

(a) An optical head having objective lenses which are compatible with a plurality type of optical discs and disposed along a circumferential direction of an optical disc by using a plurality of objective lens actuator, is disclosed, for example, in US20040090901(A1) (hereinafter called Document 1), particularly in FIG. 1.

(b) An optical head having objective lenses which are compatible with a plurality type of optical discs and disposed along a radial of an optical disc by using a plurality of objective lens actuator, is disclosed, for example, in US20040114495(A1) (hereinafter called Document 2), particularly in FIG. 2.

(c) A concept of an optical head which has an objective lens change mechanism mounting two types of objective lenses to change a lens to be used, by rotating the mechanism, is shown, for example, in the article entitled “Three Candidate Types for Head Compatible with Both BD/HD”, Nikkei Electronics Magazine, 2004.9.27 issue, at pp. 112-113 (hereinafter called Document 3), particularly in Fig. a (two-lens type).

### SUMMARY OF THE INVENTION

The technologies of the above-described Documents 1 and 2 both relate to an optical head compatible with three types of specifications of BD/DVD/CD and do not disclose the technologies compatible with four types of specifications inclusive of those of HD-DVD. The technologies of the Document 3 also relate to an optical head compatible with two types of specifications of BD/HD-DVD DVD/CD and do not disclose the technologies compatible with four types of specifications inclusive of those of DVD/CD.

An optical head disclosed in the Document 1 is associated with a problem that an offset of a tracking control signal is likely to occur, because a motion axis of an objective lens center is displaced from an optical disc rotation center while the optical disc moves traversing inner and outer circumferences of the optical disc.

Namely, in an optical disc which performs tracking control by a differential push-pull (DPP) method of converging three spots on an optical disc, for example, the positional relation between a main beam and two subsidiary beams is shifted from a proper state at the innermost and outermost circumference positions of an optical disc, even if the positional relation between the main beam and two subsidiary beams is adjusted to be in a proper state at an intermediate position between inner and outer circumferences.

Therefore, if the offset amount is large, a DPP signal for tracking control is subjected to rapid amplitude deterioration and the like, resulting in a problem that a tracking precision is deteriorated abruptly. In the Document 1, although a mount angle of a photodetector is devised to reduce the offset, it is necessary for BD and HD-DVD having a narrower track pitch than that of DVD to use some means for reducing the offset amount to 0 as much as possible in order to stabilize the tracking precision. Therefore, the method of the Document 1 is not always sufficient.

The optical head disclosed in the Document 2 has a plurality of objective lenses disposed along a disc radial direction. Therefore, when an objective lens disposed on the outer circumference side is used for recording and reproducing, it is necessary to set the objective lens disposed on the inner circumference side of an optical disc to a circumference position inner than a recording and reproducing area. There arises therefore a problem that the shape of a disc rotation spindle motor becomes complicated and the whole apparatus size becomes large.

The Document 3 shows only the concept of an optical head compatible with specifications of BD and HD-DVD, teaches not at all the concrete structure thereof, and does not describe also the rotation modes.

The present invention has been made in consideration of the above-described problems and solves these problems. An object of the present invention is to provide an optical head compatible with various types of optical discs having different optical transmission layer thicknesses, and provide an optical information recording and reproducing apparatus using such an optical head.

In order to achieve the above-described objects, according to one aspect of the present invention, an optical head for recording and reproducing information relative to an optical information recording medium having an arbitrary thickness among at least four kinds of thicknesses of a optical transmission layer including first and second different thicknesses and third and fourth different thicknesses, comprises:

a first light source for emitting light of a first center wavelength, a second light source for emitting light of a second center wavelength and a third light source for emitting light of a third center wavelength;

a first objective lens for irradiating light emitted from the first or second light source to the optical information recording medium and a second objective lens for irradiating light emitted from the first or third light source to the optical information recording medium;

a photodetector for receiving light reflected from the optical information recording medium;

an actuator for finely driving the first and second objective lenses; and

a change mechanism for changing a combination of a light source to be used and an objective lens to be used,

wherein the first, second and third light sources and the first and second objective lenses are combined in such a manner that the first light source and the first objective lens are used if the light transmission layer of the optical information recording medium has a first thickness, the first light source and the second objective lens are used if the light transmission layer has a second thickness, the second light source and the first objective lens are used if the light transmission layer has a third thickness, and the third light source and the second objective lens are used if the light transmission layer has a fourth thickness.

Preferably, the first and second objective lenses have optical characteristics having at least different numerical apertures relative to the first center wavelength, and information recording and reproducing are performed at a same wavelength for optical information recording media having different optical transmission layer thicknesses.

Preferably, the first center wavelength is 408 nm, the second center wavelength is 660 nm, the third center wavelength is 790 nm, the first thickness of the optical transmission layer of the optical information recording medium is 0.1 mm, the second thickness is 0.6 mm, the third thickness is 0.6 mm and the fourth thickness is 1.2 mm.

Preferably, the first and second objective lenses are mounted on the actuator, and the change mechanism includes a lens change mechanism for changing an objective lens to be used, in accordance with an optical information recording medium to be used, in such a manner that a position after lens change is generally coincident for both the first and second objective lenses.

Preferably, the lens change mechanism includes a member having a rotation axis for mounting the first and second objective lenses around the rotation axis and an apparatus for rotating the member around the rotation axis, and information recording and reproducing are performed by changing an objective lens to be used, in accordance with an optical information recording medium to be used.

Preferably, the lens change mechanism includes an apparatus for moving a whole of the actuator mounting the first and second objective lenses along a circumferential direction of the optical information recording medium, and information recording and reproducing are performed by changing an objective lens to be used, in accordance with an information recording medium to be used.

According to another aspect of the present invention, an optical information recording and reproducing apparatus comprises:

an optical head;

a-spindle motor for rotating an optical information recording medium;

an optical head moving mechanism for supporting and moving the optical head along a radial direction of the optical information recording medium; and

a control unit for controlling operations of the spindle motor and the optical head moving mechanism,

wherein the optical head is the optical head of the present invention described above.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram showing the structure of an optical disc according to a first embodiment of the present invention.

FIG. 2 is a schematic diagram showing the structure of an optical disc according to a second embodiment of the present invention.

FIG. 3 is a schematic diagram showing the structure of an optical information recording and reproducing apparatus using an optical head according to a third embodiment of the present invention.

FIG. 4 is a block diagram illustrating a flow of various signals in the optical information recording and reproducing apparatus shown in FIG. 3.

### DESCRIPTION OF THE EMBODIMENTS

Embodiments of the invention will be described with reference to the accompanying drawings. In the drawings, like elements are represented by identical reference numerals.

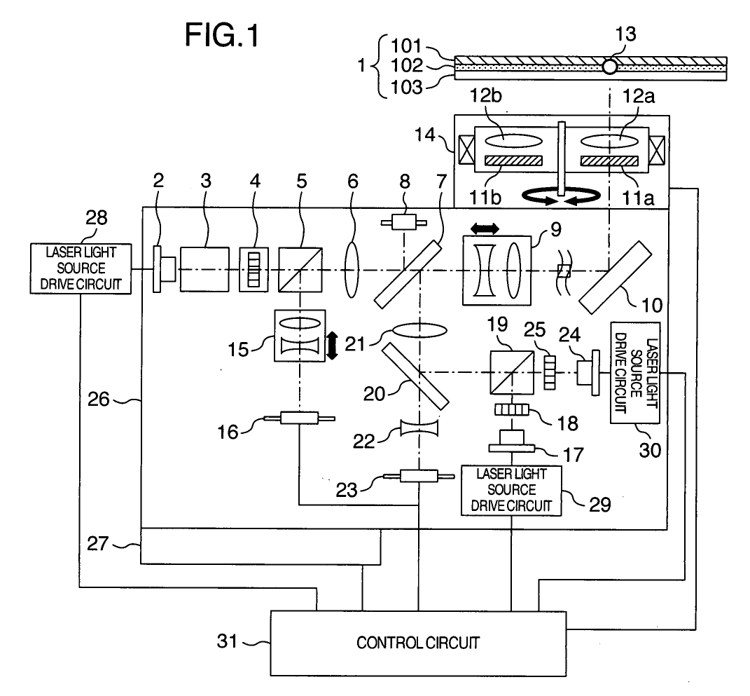

FIG. 1 shows the structure of an optical disc according to the first embodiment of the present invention.

In the following, the first embodiment of the present invention will be described with reference to FIG. 1.

In FIG. 1, reference numeral 1 represents an optical information recording medium (hereinafter called “optical disc”) to be rotated. In the present invention, recording media are used by way of example which are compatible with four types of specifications of BD, HD-DVD, DVD and CD.

This optical disc 1 has a lamination of a recording layer 102 and a protective layer 103 formed on a disc-shaped substrate 101. In the case of an optical disc of the BD specifications, a light beam having a center wavelength of about 408 nm is converged on the recording layer 102 via the protective layer 103 having a thickness of about 0.1 mm. In the case of an optical disc of the HD-DVD specifications, a light beam having a center wavelength of about 408 nm is converged on the recording layer 102 via the substrate 101 having a thickness of about 0.6 mm. In the case of an optical disc of the DVD specifications, a light beam having a center wavelength of about 660 nm is converged on the recording layer 102 via the substrate 101 having a thickness of about 0.6 mm. In the case of an optical disc of the CD specifications, a light beam having a center wavelength of about 790 nm is converged on the recording layer 102 via the substrate 101 having a thickness of about 1.2 mm.

In the following, description will be made first on a series of BD and HD-DVD using a laser light source 2 having a wavelength of about 408 nm. A light beam emitted from the laser light source 2 having a wavelength of about 408 nm is shaped from an ellipsoidal luminous intensity distribution to generally a circle luminous intensity distribution by a beam shaper 3. The beam shaper 3 may have well-known various structures, such as a combination of cylindrical lenses disposed along a same optical axis, a prism-like optical element having cylindrical planes on light input/output planes, and a diffraction grating made of liquid crystal or the like.

The light beam output from the beam shaper 3 passes through a diffraction-grating mechanism 4. The diffraction grating mechanism 4 generates diffraction light beams which are used for tracking control by a differential push-pull method. The optical disc of the present invention performs recording and reproducing relative to optical discs of two specifications of BD and HD-DVD by using light having a wavelength of about 408 nm. Two specifications define different numerical apertures (NA) and different focal distances of objective lenses and different track pitches of optical discs. Therefore, in order to perform tracking control by the differential push-pull method stably and highly precisely, it is necessary to adjust a positional relation between a converged spot formed on an optical disc by each diffraction light beam and an information recording track, for respective optical discs of different specifications.

To this end, the diffraction grating mechanism 4 controls rotation of a grating, motion relative to a light propagation direction, and the like in accordance with each optical disc 1. A liquid crystal element may be used as the diffraction grating, a grating pitch or grating angle of the liquid crystal element changing with a voltage applied thereto.

A light beam output from the diffraction grating mechanism 4 passes through a polarization beam splitter 5, and thereafter is changed to a parallel light beam by a collimator lens 6. A portion of light is input from a dichroic mirror 7 to a monitor photodetector 8. The monitor photodetector 8 may be disposed at a position where light reflected from the polarization beam splitter 5 can be used.

After passing through the dichroic mirror 7, a light beam to be used for information recording and reproducing passes through a spherical aberration compensation mechanism 9. The spherical aberration compensation mechanism 9 has a function of compensating for a spherical aberration generated by a difference between thicknesses of disc substrates through which light passes, particularly of two-layer optical discs of the BD specifications. Although a combination of concave and convex lenses along the same optical axis, i.e., a so-called beam expander, is shown in FIG. 1, a well-known element such as a liquid crystal element may also be used. The spherical aberration compensation mechanism 9 may be disposed between the collimator lens 6 and dichroic mirror 7.

An optical axis direction of a light beam output from the spherical aberration compensation mechanism 9 is bent approximately by 90° by a mirror 10, the light beam passes through a wavelength plate 11a or 11b, and an objective lens 12a or 12b forms a converged spot 13 on the disc 1. The wavelength plate 11a or 11b substantially functions as a quarter wavelength plate relative to the wavelength to be used, and outputs an approximately circularly polarized light beam. The function of the objective lenses 12a and 12b will be described later.

The wavelength plates 11a and 11b and objective lenses 12a and 12b are mounted on an actuator 14 and integrally driven in order to follow up/down vibration of the optical disc 1 and decentering of an information recording track (not shown). The objective lens 12 can be changed either to the objective lens 12a or to the objective lens 12b mounted on the actuator 14, in accordance with the type of an optical disc to which recording or reproducing is performed, by rotating mount members of the objective lenses around a predetermined axis. The objective lenses 12a and 12b are disposed spaced apart from each other by the mount members, with the centers of the objective lenses being set to the same circumference on a certain radius from the predetermined axis. Therefore, the lens center position after lens change is substantially the same for both the objective lenses 12a and 12b. With this configuration, a motion axis of the objective lens center can cross the rotation center of the optical disc 1 while an optical head 26 moves traversing inner and outer circumferences of the optical disc 1. The mount members of the objective lenses and the predetermined axis constitute a rotation mechanism for the objective lens. This rotation mechanism constitutes a change mechanism for changing a combination of a light source to be used and the objective lens 12a or 12b to be used. This change mechanism can be controlled by a signal (not shown) obtained by detecting the type of an optical disc to be used for recording and reproducing, by well-known detection technologies. The structure of the rotation mechanism may adopt well-known techniques described, for example, in JP-A-11-259885, JP-A-2001-023208 and JP-A-2002-163833.

For the purposes of description convenience, the optical axis between the spherical aberration compensation mechanism 9 and mirror 10 is shown by rotating it by 90° relative to the drawing sheet of FIG. 1.

A light beam (approximately circularly polarized light beam) reflected from the optical disc 1 passes again through the objective lens 12a or 12b and wavelength plate 11a or 11b, and is changed to a linearly polarized light beam. Since the light beam passes through the substantially quarter wavelength plate twice, the polarization direction of linearly polarized light in an output path is perpendicular to that in an input path. Therefore, a light beam passed through the mirror 10, spherical aberration compensation mechanism 9, dichroic mirror 7 and collimator lens 6 is reflected by the polarization beam splitter 5.

A light beam output from the polarization beam splitter 5 is converged on a photodetector 16 by a detection lens unit 15 to detect/reproduce an optical spot control signal for focussing and tracking and an information signal recorded on the optical disc 1.

If an astigmatism method is used as a defocus detection method and a differential push-pull method is used as a track displacement detection method, a single cylindrical lens may be used as the detection lens unit 15.

If a defocus detection sensitivity and a defocus detection range are required to be changed between an optical disc of the BD specifications and an optical disc of the HD-DVD specifications, it is preferable as shown in FIG. 1 to combine a plurality of lenses and move some or all of the lenses. A liquid crystal element or the like may also be used whose lens effect and a phase of a wave front change with an applied voltage.

Next, description will be made on a DVD series using a laser light source 17 having a wavelength of about 660 nm. A light beam emitted from the laser light source 17 having a wavelength of about 660 nm passes through a diffraction grating 18 and thereafter is reflected by a dichroic beam splitter 19 and a polarization mirror 20, and changed to parallel light beam by a collimator lens 21. A portion of a light beam output from the collimator lens 21 is input to the monitor photodetector 8 by the dichroic mirror 7. The monitor photodetector for DVD may be disposed at the position where transmission light of the polarization mirror 20 is used.

A light beam reflected from the dichroic mirror 7 passes through the spherical aberration compensation mechanism 9, mirror 10 and wavelength plate 11a, and is converged on the optical disc 1 by the objective lens 12a. The wavelength plate 11a substantially functions as a quarter wavelength plate relative to the wavelength to be used, and outputs an approximately circularly polarized light beam.

A light beam (approximately circularly polarized light beam) reflected from the optical disc 1 passes again through the objective lens 12a and wavelength plate 11a, and is changed to a linearly polarized light beam. Since the light beam passes through the substantially quarter wavelength plate twice, the polarization direction of linearly polarized light in an output path is perpendicular to that in an input path. Therefore, a light beam passed through the mirror 10, spherical aberration compensation mechanism 9, dichroic mirror 7 and collimator lens 21 passes through the polarization mirror 20.

A light beam transmitted through the polarization mirror 20 is converged on a photodetector 23 by a detection lens 22 to detect/reproduce an optical spot control signal for focussing and tracking and an information signal recorded on the optical disc 1.

Next, description will be made on a CD series using a laser light source 24 having a wavelength of about 790 nm. A light beam emitted from the laser light source 24 having a wavelength of about 790 nm passes through a diffraction grating 25 and thereafter is reflected by the dichroic beam splitter 19 and polarization mirror 20, and changed to a parallel light beam by the collimator lens 21. A portion of a light beam output from the collimator lens 21 is input to the monitor photodetector 8 by the dichroic mirror 7. The monitor photodetector 8 for DVD may be disposed at the position where transmission light of the polarization mirror 20 is used.

A light beam reflected from the dichroic mirror 7 passes through the spherical aberration compensation mechanism 9, mirror 10 and wavelength plate 11b, and is converged on the optical disc 1 by the objective lens 12b. The wavelength plate 11b substantially functions as a quarter wavelength plate relative to the wavelength to be used, and outputs an approximately circularly polarized light beam.

A light beam (approximately circularly polarized light beam) reflected from the optical disc 1 passes again through the objective lens 12b and wavelength plate 11b, and is changed to a linearly polarized light beam. Since the light beam passes through the substantially quarter wavelength plate twice, the polarization direction of linearly polarized light in an output path is perpendicular to that in an input path. Therefore, a light beam passed through the mirror 10, spherical aberration compensation mechanism 9, dichroic mirror 7 and collimator lens 21 passes through the polarization mirror 20.

A light beam transmitted through the polarization mirror 20 is converged on the photodetector 23 by the detection lens 22 to detect/reproduce an optical spot control signal for focussing and tracking and an information signal recorded on the optical disc 1.

In the foregoing description, the optical system is structured by disposing discrete optical components by way of example. The present invention is also applicable to an optical system structured by integrating a laser light source, a photodetector and the like, i.e., by using a so-called laser module.

The above-described optical system, optical components and the like are accommodated in a housing to constitute the optical head 26. For example, the optical head 26 can be moved along a radial direction of the optical disc 1 by a motion mechanism 27 constituted of a linear motor, a stepping motor and the like. Optical outputs of the laser light sources 2, 17 and 24 are controlled by laser light source drive circuits 28, 29 and 30. Although three laser light source drive circuits are shown in FIG. 1, one integrated laser light source drive circuit may also be used.

A control circuit 31 controls the whole optical head including the actuator 14, motion mechanism 27 and laser light source drive circuits 28, 29 and 30.

According to the constitution of the present invention, while the optical head 26 moves traversing inner and outer circumferences of the optical disc 1, the motion axis of the objective lens center can be set so that the motion axis crosses the rotation center of the optical disc 1. Accordingly, if the differential push-pull method is used as the track displacement detection method, the positional relation between three focussed spots formed on the optical disc 1 and the information recording track will not change even if the optical head 26 moves traversing inner and outer circumferences. There is therefore the effect that an offset of a track displacement signal will not be generated.

Next, description will be made on the functions of the objective lenses 12a and 12b of the present invention. Various objective lenses have been proposed which are compatible with BD/DVD, BD/DVD/CD, HD-DVD/DVD, HD-DVD/DVD/CD. However, since these objective lenses have merits and demerits in terms of a light transmissivity, a lens weight and the like, an objective lens compatible with BD/HD-DVD/DVD/CD is not still practically used. It is considered difficult to realize an objective lens compatible with BD/HD-DVD because different numerical apertures (NA) and different thicknesses of the optical transmission layer of an optical disc are used at the same wavelength. According to the present invention, two objective lenses are used to realize an optical head capable of recording and reproducing optical discs of four types of specifications of BD/HD-DVD/DVD/CD.

In the present invention, it is assumed that the first objective lens 12a is compatible with BD/DVD. For recording and reproducing an optical disc 1 of the BD specifications, the laser light source 2 having a wavelength of about 408 nm is used, and a light beam is passed through the protective layer having a thickness of about 0.1 mm and converged at NA of 0.85. For recording and reproducing an optical disc 1 of the DVD specifications, the laser light source 17 having a wavelength of about 660 nm is used, and a light beam is passed through the substrate having a thickness of about 0.6 mm and converged at NA of 0.6 to 0.65.

It is assumed that the second objective lens 12b is compatible with HD-DVD/CD. For recording and reproducing an optical disc 1 of the HD-DVD specifications, the laser light source 2 having a wavelength of about 408 nm is used, and a light beam is passed through the substrate having a thickness of about 0.6 mm and converged at NA of 0.65. For recording and reproducing an optical disc 1 of the CD specifications, the laser light source 24 having a wavelength of about 790 nm is used, and a light beam is passed through the substrate having a thickness of about 1.2 mm and converged at NA of 0.45 to 0.55. By using the above-described combinations, both the objective lenses 12a and 12b can suppress a light transmissivity from being lowered and a weight from being increased, so that recording and reproducing at multiple-high speed are possible.

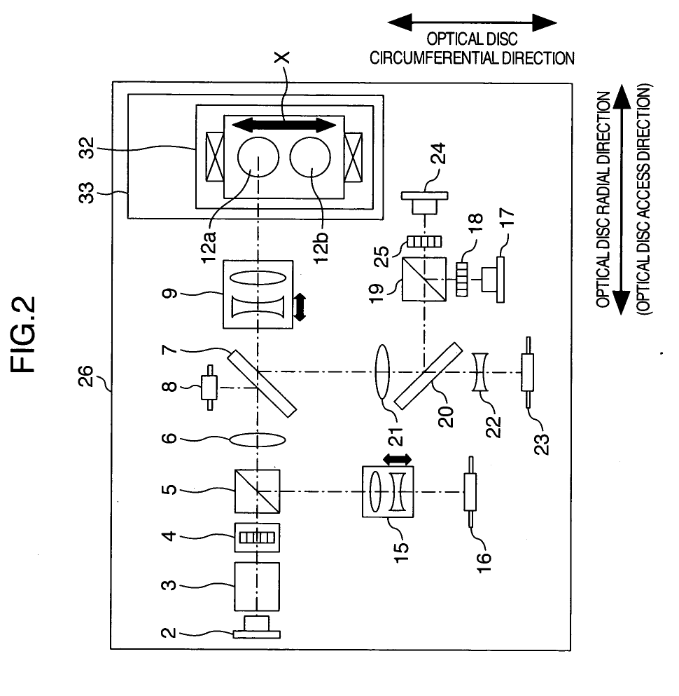

Next, the second embodiment of the present invention will be described with reference to FIG. 2. FIG. 2 is a diagram showing an optical head 26 viewed from the front side of an optical disc 1. A light beam converged on the optical disc 1 propagates from the back side to the front side of the drawing sheet.

In the second embodiment, an objective lens actuator 32 is mounted on a motion mechanism 33. When an objective lens to be used is to be changed, the motion mechanism 33 slides the whole actuator 32 along a circumferential direction of an optical disc 1 indicated by an arrow X. The objective lenses 12a and 12b are disposed spaced apart from each other in such a manner that a distance between centers of the objective lenses is the same as a slide distance of the actuator 32. Therefore, the lens center position after lens change is substantially the same for both the objective lenses 12a and 12b. With this configuration, a motion axis of the objective lens center can cross the rotation center of the optical disc 1 while an optical head 26 moves traversing inner and outer circumferences of the optical disc 1. The motion mechanism 33 constitutes a lens change mechanism. This motion mechanism 33 constitutes a change mechanism for changing a combination of the laser light source to be used and the objective lens 12a or 12b to be used. This change mechanism can be controlled by a signal (not shown) obtained by detecting the type of an optical disc to be used for recording and reproducing, by well-known detection technologies.

The motion mechanism 33 for moving the actuator 32 may adopt various methods such as a combination of a feed motor and gears, magnetic attraction and repulsion by electromagnets or coils, and piezoelectric effects by piezo elements. Constituent elements other than the actuator 32 and motion mechanism 33 shown in FIG. 2 are similar to those of the first embodiment shown in FIG. 1, and the description thereof is omitted.

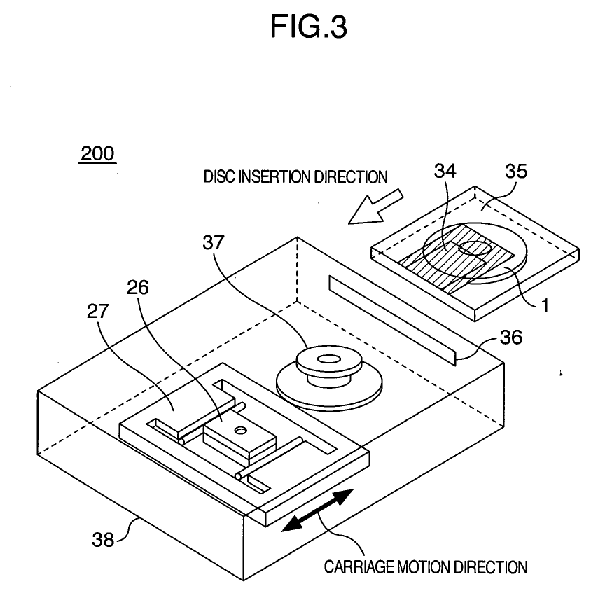

FIG. 3 is a schematic diagram showing the structure of an optical information recording and reproducing apparatus according to the third embodiment of the present invention. The third embodiment will be described below with reference to FIG. 3.

Referring to FIG. 3, the optical information recording and reproducing apparatus 200 has an optical head 26 described with reference to the first or second embodiment. As shown in FIG. 3, the optical head 26 described with reference to the first or second embodiment is moved along the radial direction of an optical disc 1 by an optical head motion mechanism 27. The optical disc 1 is accommodated in a cartridge 35 having a dust-proof function. A head access port (not shown) formed in the cartridge 35 is closed or opened by a shutter 34. The cartridge 35 accommodating the optical disc 1 is inserted into the optical information recording and reproducing apparatus 200 via an opening 36, and a spindle motor 37 rotates the disc 1.

The whole apparatus is covered with a dust-proof case 38. The optical head motion mechanism 27 may adopt any of various well-known methods such as gears, screws, stepping motors, and linear motors. Although the cartridge 35 is used for accommodating the optical disc 1, the cartridge 35 may not be used. Although the mechanism for inserting the optical disc 1 is not shown, various well-known methods may be used such as inserting the optical disc placed on a tray, and automatically or manually inserting the optical disc 1 or cartridge 35 itself.

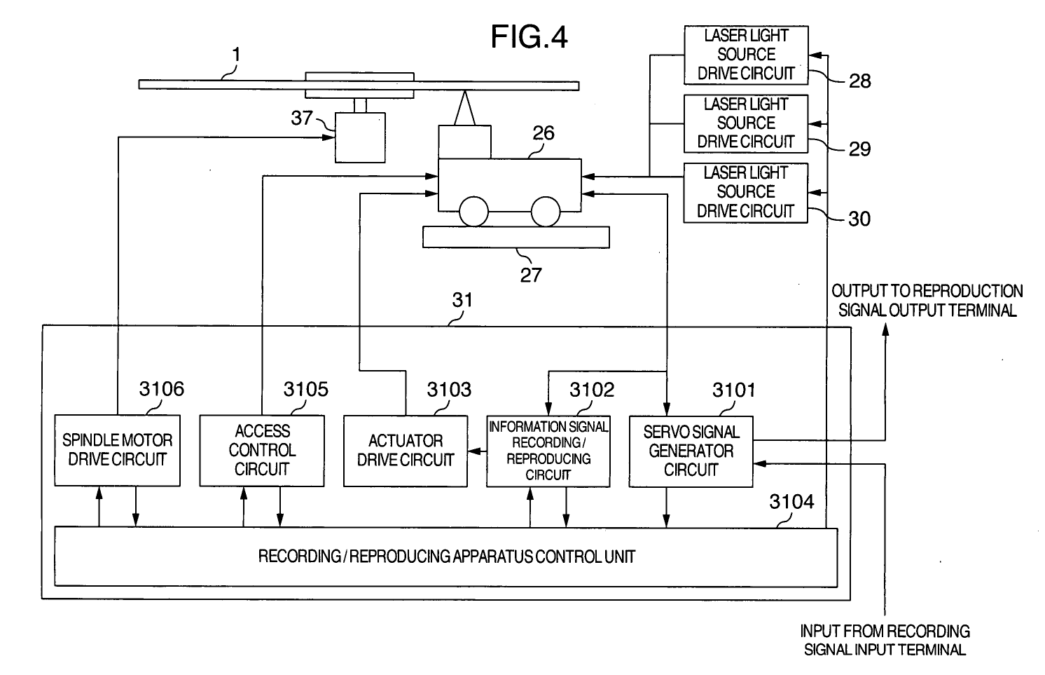

FIG. 4 illustrates a flow of various signals in the optical information recording and reproducing apparatus 200 shown in FIG. 3.

With reference to FIG. 4, description will be made on a flow of various signals in the optical information recording and reproducing apparatus 200. Various detection signals detected with an optical head 26 are sent to a servo signal generator circuit 3101 and an information signal recording and reproducing circuit 3102, respectively in a control circuit 31.

The servo signal generator circuit 3101 generates optical spot control signals such as a focus error signal and a tracking error signal from these detection signals, and drives an actuator 14 or 32 (refer to FIG. 1 or 2) in the optical head 27 via an actuator drive circuit 3103, in accordance with the optical spot control signals.

In the information signal recording and reproducing circuit 3102, during reproduction, information signals recorded in the optical disc 1 are reproduced from the detection signals and output via a reproduction signal output terminal. During recording, a record signal input via a record signal input terminal is subjected to a recording process by the information signal recording and reproducing circuit 3102 and thereafter recorded in the optical disc 1 by the optical head 26.

Some signals obtained by the servo signal generator circuit 3101 and information signal reproducing circuit 3102 are sent to an apparatus control unit 3104. The apparatus control unit 3104 controls the whole operation of the optical information recording and reproducing apparatus 200 in accordance with the above-described various signals.

An access control circuit 3105, a spindle motor drive circuit 3106 and laser light source drive circuits 28, 29 and 30 are connected to the apparatus control unit 3104 to perform an access direction (radial direction of the disc 1) position control of the optical head 26, a rotation control of the spindle motor 37, a laser light source luminous output control in accordance with information recording and reproducing and a drive control of a light beam (flux) conversion means.

Although the structure of the optical information recording and reproducing apparatus has been described with reference to FIG. 4, the structure is not limited only to that shown in FIG. 4. For example, in FIG. 4, although the processes of the servo signal generator circuit 3101, information signal reproducing circuit 3102, actuator drive circuit 3103, apparatus control unit 3104, access control circuit 3105 and spindle motor drive circuit 3106 are executed in the control circuit 31, the processes are not necessarily required to be executed in the control circuit 31, but any of the processes may be executed outside the control circuit 31.

In the foregoing description, although the flow of various signals is described by using one series, an individual signal processing series may be configured for each of BD/HD-DVD/DVD/CD.

As described so far, according to the above-described embodiments, a stable differential push-pull tracking control is possible even for an optical head using an actuator mounting a plurality of objective lenses. Accordingly, an optical head and an optical disc apparatus or optical information recording and reproducing apparatus can be provided which are compatible with both the BD and HD-DVD specifications and also with DVD media and CD media.

It should be further understood by those skilled in the art that although the foregoing description has been made on embodiments of the invention, the invention is not limited thereto and various changes and modifications may be made without departing from the spirit of the invention and the scope of the appended claims.

1. An optical head for recording and reproducing information relative to an optical information recording medium having an arbitrary thickness among at least four kinds of thicknesses of a optical transmission layer including first and second different thicknesses and third and fourth different thicknesses, comprising:
a first light source for emitting light of a first center wavelength, a second light source for emitting light of a second center wavelength and a third light source for emitting light of a third center wavelength;
a first objective lens for irradiating light emitted from said first or second light source to said optical information recording medium and a second objective lens for irradiating light emitted from said first or third light source to said optical information recording medium;
a photodetector for receiving light reflected from said optical information recording medium;
an actuator for finely driving said first and second objective lenses; and
a change mechanism for changing a combination of a light source to be used and an objective lens to be used,
wherein said first, second and third light sources and said first and second objective lenses are combined in such a manner that said first light source and said first objective lens are used if said light transmission layer of said optical information recording medium has a first thickness, said first light source and said second objective lens are used if said light transmission layer has a second thickness, said second light source and said first objective lens are used if said light transmission layer has a third thickness, and said third light source and said second objective lens are used if said light transmission layer has a fourth thickness.

2. The optical head according to claim 1, wherein said first and second objective lenses have optical characteristics having at least different numerical apertures relative to the light of the first wavelength, and information recording and reproducing are performed at a same wavelength for optical information recording media having different optical transmission layer thicknesses.

3. The optical head according to claim 1, wherein said first and second objective lenses are mounted on said actuator, and said change mechanism includes a lens change mechanism for changing an objective lens to be used, in accordance with an optical information recording medium to be used, in such a manner that a position after lens change is generally coincident for both said first and second objective lenses.

4. The optical head according to claim 3, wherein said lens change mechanism includes a member having a rotation axis for mounting said first and second objective lenses around the rotation axis and an apparatus for rotating said member around the rotation axis, and information recording and reproducing are performed by changing an objective lens to be used, in accordance with an optical information recording medium to be used.

5. The optical head according to claim 3, wherein said lens change mechanism includes an apparatus for moving a whole of said actuator mounting said first and second objective lenses along a circumferential direction of said optical information recording medium, and information recording and reproducing are performed by changing an objective lens to be used, in accordance with an information recording medium to be used.

6. The optical head according to claim 1, wherein said first and second objective lenses are mounted on said actuator, and said change mechanism includes a lens change mechanism for changing an objective lens to be used, in accordance with an optical information recording medium to be used.

7. The optical head according to claim 6, wherein said lens change mechanism includes a member having a rotation axis for mounting said first and second objective lenses around the rotation axis and an apparatus for rotating said member around the rotation, and information recording and reproducing are performed by changing an objective lens to be used, in accordance with an optical information recording medium to be used.

8. The optical head according to claim 6, wherein said lens change mechanism includes an apparatus for moving a whole of said actuator mounting said first and second objective lenses along a circumferential direction of said optical information recording medium, and information recording and reproducing are performed by changing an objective lens to be used, in accordance with an information recording medium to be used.

9. The optical head according to claim 1, wherein said first center wavelength is 408 nm, said second center wavelength is 660 nm, said third center wavelength is 790 nm, said first thickness of the optical transmission layer of said optical information recording medium is 0.1 mm, said second thickness is 0.6 mm, said third thickness is 0.6 mm and said fourth thickness is 1.2 mm.

10. The optical head according to claim 1, wherein said first objective lens has optical characteristics of converging emitted light of said first center wavelength substantially at a numerical aperture of 0.85 for said optical information recording medium having the optical transmission layer having said first thickness and converging emitted light of said second center wavelength substantially at a numerical aperture of 0.6 to 0.65 for said optical information recording medium having the optical transmission layer having said third thickness, and said second objective lens has optical characteristics of converging emitted light of said first center wavelength substantially at a numerical aperture of 0.65 for said optical information recording medium having the optical transmission layer having said second thickness and converging emitted light of said third center wavelength substantially at a numerical aperture of 0.45 to 0.55 for said optical information recording medium having the optical transmission layer having said third thickness.

11. The optical head according to claim 1, wherein said photodetector includes a first photodetector for detecting light having said first center frequency and reflected from said optical information recording medium having the optical transmission layer having said first or second thickness and a second photodetector for detecting light having said second or third center frequency and reflected from said optical information recording medium having the optical transmission layer having said third or fourth thickness.

12. An optical information recording and reproducing apparatus comprising:
an optical head;
a spindle motor for rotating an optical information recording medium;
an optical head moving mechanism for supporting and moving said optical head along a radial direction of said optical information recording medium; and
a control unit for controlling operations of said spindle motor and said optical head moving mechanism,
wherein said optical head is the optical head according to claim 1.

13. An optical information recording and reproducing apparatus comprising:
an optical head;
a spindle motor for rotating an optical information recording medium;
an optical head moving mechanism for supporting and moving said optical head along a radial direction of said optical information recording medium; and
a control unit for controlling operations of said spindle motor and said optical head moving mechanism,
wherein said optical head is the optical head according to claim 2.

14. An optical information recording and reproducing apparatus comprising:
an optical head;
a spindle motor for rotating an optical information recording medium;
an optical head moving mechanism for supporting and moving said optical head along a radial direction of said optical information recording medium; and
a control unit for controlling operations of said spindle motor and said optical head moving mechanism,
wherein said optical head is the optical head according to claim 3.

15. An optical information recording and reproducing apparatus comprising:
an optical head;
a spindle motor for rotating an optical information recording medium;
an optical head moving mechanism for supporting and moving said optical head along a radial direction of said optical information recording medium; and
a control unit for controlling operations of said spindle motor and said optical head moving mechanism,
wherein said optical head is the optical head according to claim 4.

16. An optical information recording and reproducing apparatus comprising:
an optical head;
a spindle motor for rotating an optical information recording medium;
an optical head moving mechanism for supporting and moving said optical head along a radial direction of said optical information recording medium; and
a control unit for controlling operations of said spindle motor and said optical head moving mechanism,
wherein said optical head is the optical head according to claim 5.

17. An optical information recording and reproducing apparatus comprising:
an optical head;
a spindle motor for rotating an optical information recording medium;
an optical head moving mechanism for supporting and moving said optical head along a radial direction of said optical information recording medium; and
a control unit for controlling operations of said spindle motor and said optical head moving mechanism,
wherein said optical head is the optical head according to claim 9.
